(19) United States
(12) Patent Application Publication
(10) Pub. No.: US 2021/0264457 A1
(43) Pub. Date: Aug. 26, 2021

(54) INTEGRATING SOCIAL MEDIA AND REWARDS FOR MILESTONE ACHIEVEMENT

(71) Applicant: Wells Fargo Bank, N.A., San Francisco, CA (US)

(72) Inventors: Amanda Booska, Angwin, CA (US); Lori Deselms, San Francisco, CA (US); David Patron, San Francisco, CA (US)

(21) Appl. No.: 15/393,843

(22) Filed: Dec. 29, 2016

(51) Int. Cl. G06Q 30/02; G06Q 50/00

(52) U.S. Cl. CPC G06Q 30/0224; G06Q 30/0239; G06Q 50/01

(57) ABSTRACT

Systems, methods, and apparatuses for delivering reward offers are disclosed. The reward offer distribution system is configured to receive social media information concerning a customer, determine a characteristic of the received social media information based on the content of the received social media information, retrieve reward offer content from a reward offer database to be delivered to the customer based on the determined characteristic, and transmit the retrieved financial reward offer content to a computing device associated with the customer.

### TECHNICAL FIELD

The present invention relates generally to the field of delivery of financial rewards to customers of a financial institution.

### BACKGROUND

Customers have financial milestones and goals that can be furthered by opportunistic use of rewards. Typically, however, many customers are not aware of the potential reward programs or opportunities for gaining, or alternatively, for using rewards already earned. As a result, customers may not be optimally earning and spending rewards such that the customer is actively working toward their financial goals and milestones. In this regard, financial institutions and customers of those institutions may benefit from a system that delivers financial reward opportunities that are particularly tailored to customers' individual circumstances.

### SUMMARY

One embodiment relates to a financial institution computing system associated with a financial institution. The financial institution computing system includes a customer database configured to store customer information for a customer of the financial institution, wherein the customer uses a social media account associated with a social media company. The financial institution computing system also includes a processing circuit comprising a processor and memory, the memory structured to store instructions that are executable by the processor and cause the processing circuit to receive social media information concerning social media usage of the customer. The instructions also cause the processing circuit to determine a characteristic of the received social media information based on the content of the received social media information. The instructions also cause the processing circuit to retrieve reward offer content from a reward offer database to be delivered to the customer based on the determined characteristic. The instructions also cause the processing circuit to transmit the financial reward offer content to a customer device associated with the customer.

Another embodiment relates to a computer-implemented method. The method includes receiving, by a financial institution computing system, social media information concerning a customer. The method also includes determining, by the financial institution computing system, a characteristic of the received social media information based on the content of the received social media information. The method also includes retrieving, by the financial institution computing system, reward offer content stored in a reward offer database to be delivered to the customer based on the determined characteristic. The method also includes transmitting, by the financial institution computing system, the reward offer content to a computing device associated with the customer.

Another embodiment relates to a mobile device. The mobile device includes a network interface configured to communicate data over a network. The mobile device also includes an input/output device structured to exchange data with a customer. The mobile device also includes a processor. The mobile device also includes a memory, the memory having executable instructions stored thereon that are structured such that, when executed by the processor, the processor receives a first input from the customer via the input/output device, the first input indicating a customer preference to communicate information on a social media platform related to an event. The processor also transmits, over the network by the network interface, the information contained in the first input to a computing system associated with the financial institution. The processor also receives, over the network by the network interface, a financial reward offer from the computing system associated with the financial institution, the financial reward offer being related to the event. The processor also presents the received financial reward offer to the customer via the input/output device.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### BRIEF DESCRIPTION OF THE DRAWINGS

FIG. 1 is a block diagram of a financial reward offer distribution system, according to an example embodiment

FIG. 2 is a flow diagram of a method of delivering financial reward offers to a customer, according to an example embodiment.

FIG. 3 is an interface on a display of a customer device, including graphics informing the customer about a financial reward program, according to an example embodiment.

FIG. 4 is an interface on a display of a customer device, including graphics displaying financial reward offers, according to an example embodiment.

FIG. 5 is a flow diagram of a method of enabling customers of a financial institution to pool their financial rewards to benefit other customers of the financial institution, according to an example embodiment.

FIG. 6 is an interface on a display of a customer device, including graphics displaying an opportunity to pool financial rewards to facilitate a customer accomplishing a financial goal, according to an example embodiment.

### DETAILED DESCRIPTION

Referring generally to the figures, various systems, methods, and apparatuses for facilitating generation and distribution of financial reward offers and recommendations through a financial reward offer distribution system are described herein. More particularly, systems and methods for facilitating optimal utilization of financial rewards for customers of a financial institution are described herein.

According to various example embodiments, a financial reward program at the financial institution is maintained and facilitated by the financial reward offer distribution system described herein. The financial reward offer distribution system manages the offer and distribution of rewards to a customer. In one arrangement, a customer may agree to participate in a financial reward program offered by the financial institution. Alternatively, the customer may be prompted by the financial institution (e.g., via the financial reward offer distribution system) to participate in the financial reward program provided by the financial institution. When referred to herein, the term “reward program” includes arrangements between a financial institution and customers of the financial institution whereby the customers may earn rewards that are based on the customers' relationship with the financial institution. For example, some reward programs involve a customer earning financial rewards using a payment account (e.g., a credit account, debit account, or the like) at the financial institution. The customer may earn financial rewards in the form of reward “points” by engaging in transactions using the payment account. After these points are earned, the customer may redeem the points, which may involve the financial institution offsetting at least a portion of a payment for a customer transaction. The systems, methods, and apparatuses herein are applicable to any situation where a customer may obtain any sort of financial benefit from the financial institution.

The embodiments described herein solve the technical and internet-centric problem of combining information communicated over social media with financial reward information stored at the financial institution to facilitate the delivery of personalized financial reward offers to customers. By leveraging social media content and customer financial reward information, the systems and methods herein assemble unique information sets. In this regard, the systems, methods, and apparatuses described herein integrate previously unconnected data to provide personalized financial reward offers to the benefit of customers using social media platforms. Accordingly, the customer can potentially increase utilization of earned financial rewards and potential earning of such rewards, thus potentially increasing customer usage of payment accounts associated with the financial institution. Additionally, the generated reward earning offers enable the customer to earn an enhanced amount of financial rewards (e.g., a multiple of what the customer ordinarily earns by using a payment account associated with the financial institution) at identified merchants. Enhanced financial rewards may enable the customer to reach a financial goal sooner than without the financial reward program.

An example implementation may be described as follows. A customer registers for a financial reward program (e.g., by signing up for a credit account). During the registration process, the customer is presented with a registration interface on a customer computing device that prompts the customer to input various preferences and financial goal information. One preference entered by the customer includes agreeing to allow the financial institution to monitor the customer's social media usage (e.g., communications made by the customer on a social media platform). The contemplated financial reward offer distribution system is configured to assess available information concerning the customer to determine reward offers (e.g., reward burning opportunities and reward earning opportunities) that are appropriate for the customer. The contemplated system may further be configured to associate the reward offers with various events or communications (e.g., triggering events) that occur in relation to the customer. When referred to herein, “triggering events” include identified circumstances that, if detected in relation to the customer based on customer social media usage information, trigger the delivery of a financial reward offer to the customer. The contemplated system monitors the customer's social media usage and determines if the social media usage is indicative of any of the triggering events. Beneficially, using customer information previously gathered, the financial institution is aware that a customer may be receptive to particular reward offers. Accordingly, upon detection of a triggering event, the reward offer distribution system generates and provides a reward offer to the customer computing device to display it to the customer.

In operation, the financial reward offer distribution system facilitates the customer receiving financial reward offers that reflect customer preferences, financial goals, milestones, and life events. Reward offers delivered to the customer are updated to reflect customer circumstances as indicated by social media usage of the customer as well as other users that are associated with the customer (e.g., friends, family members, colleagues, contacts, social media connections, etc.). Other embodiments may include different arrangements where different entities monitor customer social media usage and deliver financial reward offers to the customer without departing from the spirit or scope of the present disclosure.

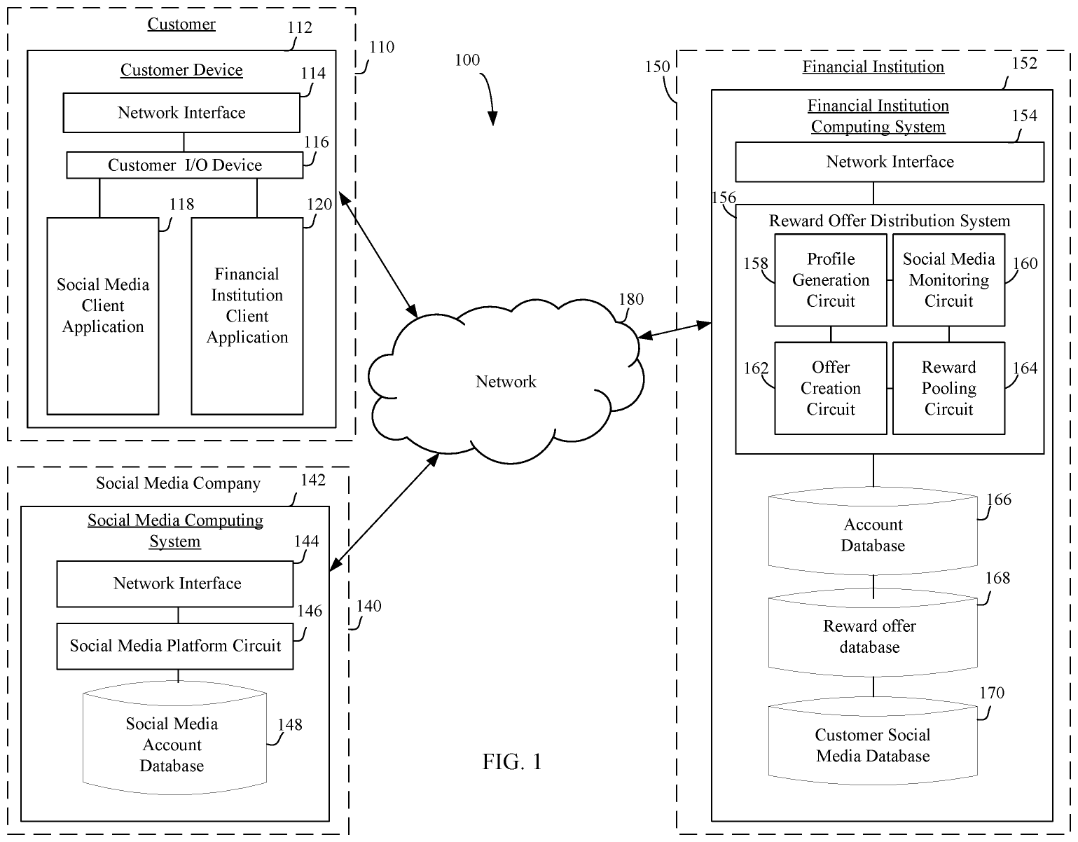

Referring now to FIG. 1, a block diagram of a financial reward offer distribution system 100 is shown, according to an example embodiment. As will be described in further detail below, the financial reward offer distribution system 100 facilitates the delivery of targeted financial reward offers and opportunities to a customer 110 of a financial institution 150. The financial reward offer distribution system 100 receives information regarding the customer 110 to generate the targeted offers and opportunities, such as monitored information from a social media account of the customer 110. The financial reward offer distribution system 100 additionally provides for and monitors communications between the customer 110 and/or other registered users of the system 100 to facilitate pooling of reward offers to help customers achieve financial milestones.

The customer 110 includes any customer of the financial institution 150 who is or may be eligible to participate in the financial rewards program offered by the financial institution 150. The customer 110 has at least one financial rewards account at the financial institution 150 that may be associated with at least one payment account held by the customer 110 at the financial institution 150.

In one arrangement of the financial reward offer distribution system 100, customers 110 register for a financial reward program offered by the financial institution 150 and, by so doing, agree to share certain information with the financial institution 150. This shared information includes information from social media accounts of the customer that are associated with a social media platform implemented by a social media computing system 142 associated with a social media company 140. For example, upon receiving a request to register for the financial reward program from a customer 110, a financial institution computing system 152 associated with the financial institution 150 may be configured to initiate a sequence to implement an application programing interface (API) on a customer device 112 associated with the customer 110, as described further herein.

In other arrangements of the reward offer distribution system 100, the relationship between the financial institution 150 and the social media company 140 takes a different form. In one example arrangement, the social media company 140 agrees to transfer certain information concerning customers to the financial institution computing system 152. The transferred information may be pre-identified by an agreement between the financial institution 150 and the social media company 140, such that the social media computing system 142 is configured to monitor the social media usage of customers 110 of the financial institution 150 for the pre-identified information so the financial institution computing system 152 only receives a subset of customer social media usage information.

The financial reward offer distribution system 100 includes a financial institution computing system 152 associated with a financial institution 150 and a customer device 112 associated with a customer 110, whereby these components are communicably coupled to each other over a network 180. The network 180 provides communicable and operative coupling between the customer device 112 and the financial institution computing system 152, and other components disclosed and described herein to provide and facilitate the exchange of communications (e.g., data, instructions, messages, values, commands, etc.). The network 180 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network includes the Internet. In some embodiments, the network 180 may further include a proprietary banking network to provide secure or substantially secure communications.

The customer device 112 is a computing device associated with a customer 110 of the financial institution 150, where the customer is also a user of one or more social media platforms associated with one or more social media companies 140. The customer device 112 includes any type of computing device that may be used to conduct financial transactions (including redemption and earning of rewards) and/or receive information from the financial institution computing system 152. In some arrangements, the customer 110 uses the customer device 112 to both communicate information to social media users over the network 180 via a social media platform as well as communicate information with the financial institution computing system 152. In this regard, the customer device 112 may include any wearable or non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. Customer device 112 may also include any type of mobile device including, but not limited to, a phone (e.g., smart phone, etc.), tablet, personal digital assistant, and/or computing devices (e.g., desktop computer, laptop computer, personal digital assistant, etc.).

In the example embodiment shown, the customer device 112 includes a network interface 114, enabling the customer device 112 to exchange information over the network 180, a social media client application 118, a financial institution client application 120, and a customer input/output (“I/O”) device 116. The customer I/O device 116 includes hardware and associated logics configured to enable the customer device 112 to exchange information with the customer 110, the financial institution computing system 152 and/or social media computing system 142, as will be described in greater detail below. An input device or component of the customer I/O device 116 allows the user to provide information to the customer device 112, and may include, for example, a mechanical keyboard, a touchscreen, a microphone, a camera, a fingerprint scanner, any user input device engageable with the customer device 112 via a USB, serial cable, Ethernet cable, and so on. An output device or component of the customer I/O device 116 allows the user to receive information from the customer device 112, and may include, for example, a digital display, a speaker, illuminating icons, LEDs, and so on.

The social media client application 118 is communicably coupled to the social media computing system 142 (e.g., the social media platform circuit 146 and the social media account database 148) and is structured to permit management of the customer's social media accounts and communications associated with a social media platform. In some embodiments, the social media client application 118 is a separate software application implemented on the customer device 112. The social media client application 118 may be downloaded by the customer device 112 prior to its usage, hard coded into the memory of the customer device, or be a web-based interface application such that the customer device 112 may provide a web browser to the application, which may be executed remotely from the customer device 112. In the latter instance, the customer 110 may have to log onto or access the web-based interface before usage of the applications. Further, and in this regard, the social media client application 118 may be supported by a separate computing system including one or more servers, processors, network interface circuits, etc., that transmit applications for use to the computing device. In certain embodiments, the social media client application 118 includes an API and/or a software development kit (SDK) that facilitate the integration of other applications (e.g., the financial institution client application 120) with the social media client application 118 such that the financial institution computing system 152 receives customer social media usage information over the network 180. The financial institution 150 is thus delivered customer social media communications, and is able to use the content of those social media communications to deliver targeted reward offers to the customer 110. In some embodiments, the customer device 112 includes multiple social media client applications 118 associated with multiple social media companies 140.

Irrespective of the form that the social media client application 118 takes, the social media client application 118 is structured to provide displays to the customer device 112 that enable the customer 110 to manage social media accounts as well as communicate information over a social media platform. These displays may include content displaying customer social media profile information, recent communications of customer social media connections, advertisements, and the like. Further, in some embodiments, the social media client application 118 also provides displays that permit the customer to communicate information to other users of the social media platform.

The financial institution client application 120 is communicably coupled to the financial institution computing system 152 (e.g., reward offer distribution system 156, the financial institution account database 166, the reward offer database 168, or the customer social media database 170) and is structured to permit management of the customer financial accounts and transactions. In some embodiments, the financial institution client application 120 may be incorporated with an existing application in use by the financial institution 150 (e.g., a mobile banking application or a mobile wallet application). In other embodiments, the financial institution client application 120 is a separate software application implemented on the customer device 112. The financial institution client application 120 may be downloaded by the customer device 112 prior to its usage, hard coded into the memory of the customer device, or be a web-based interface application such that the customer device 112 may provide a web browser to the application, which may be executed remotely from the customer device 112. In the latter instance, the customer 110 may have to log onto or access the web-based interface before usage of the applications. Further, and in this regard, the financial institution client application 120 may be supported by a separate computing system including one or more servers, processors, network interface circuits, etc. that transmit applications for use to the customer device 112. In certain embodiments, the financial institution client application 120 includes an API and/or a software development kit (SDK) that facilitate the integration of other applications (e.g., the social media client application 118) with the financial institution client application 120.

Irrespective of the form that the financial institution client application 120 takes, the financial institution client application 120 is structured to provide displays to the customer device 112 that enable the customer 110 to manage financial accounts. These displays may be indicative of current account balances, pending transactions, profile information (e.g., contact information), and the like. Further, in some embodiments, the financial institution client application 120 also is structured to present displays pertaining to a financial reward program to the customer 110. Financial reward program displays include, for example, displays providing the customer 110 the ability to input information pertaining to preferences relating to the financial reward program, information pertaining to customer financial goals, and the like. Financial reward program displays also include financial reward offers (e.g., reward earning opportunities and reward redemption opportunities) that are individually tailored to the customer 110 based on information received by the financial institution computing system 152 describing customer interactions with the social media client application 118.

Social media computing system 142 includes a network interface 144 enabling the social media computing system 142 to exchange data over the network 180, a social media platform circuit 146, and a social media account database 148. Although shown as a separate computing system, in some arrangements, the social media computing system 142 is incorporated into the financial institution computing system 152 described herein. In these embodiments, all of the functions of the social media computing system 142 can be performed using the financial institution computing system 152.

The social media platform circuit 146 controls operations of the social media computing system 142 using data received from customer devices 112. In some arrangements, the social media platform circuit 146 is configured to determine individual member data that can be used and communicated to a financial institution computing system 152 in order to facilitate financial reward offers being delivered to its customers by the financial institution computing system 152. In some arrangements, the social media platform circuit 146, the network interface circuit 144, and the social media account database 148 reside in part on different servers in relation to other components or to the whole of a particular component.

The social media account database 148 is a storage device that is structured to retrievably store customer social media information, and may include non-transient data storage mediums (e.g., local disc or flash-based hard drives, local network servers, and the like) or remote data facilities (e.g., cloud servers). The social media account database 148 includes personal customer information (e.g., names, addresses, phone numbers, and so on), identification information, and customer social media usage information (e.g., customer social media activity information, information that the customer has communicated over the network 180 to other users of the social media platform, and the like). The social media account database 148 may also include information pertaining to a plurality of customers of the financial institution 150, including, for example, whether the customers have registered for participation in a financial reward program associated with the financial institution 150.

Still referring to FIG. 1, the financial institution computing system 152 is a computing system associated with a financial institution 150 that delivers reward offers and opportunities to the customer 110. The financial institution 150 may include commercial or private banks, credit unions, investment brokerages, or the like. The financial institution computing system 152 includes a network interface 154, a reward offer distribution system 156, an account database 166, reward offer database 168, and a customer social media database 170. The network interface 154 is configured to facilitate the communication of the financial institution computing system 152 with external computing devices (e.g., customer devices 112 or the social media computing system 142) over the network 180.

The account database 166 is a storage device structured to retrievably store customer information relating to the various operations discussed herein, and may include non-transient data storage mediums (e.g., local disc or flash-based hard drives, local network servers, and the like) or remote data storage facilities (e.g., cloud servers). The account database 166 includes personal customer information (e.g., names, addresses, phone numbers, and so on), identification information (e.g., driver's license numbers, standard biometric data, and so on), and customer financial information (e.g., token information, account numbers, account balances, available credit, credit history, transaction histories, and so on). In some arrangements, account database 166 includes information relating to any financial rewards that the customer has earned by using any accounts held by the customer 110 at the financial institution 150. For example, the customer 110 may have an account at the financial institution 150 that is associated with a payment card (e.g., credit card, debit card, or the like), and the account may be configured such that the customer 110 earns financial rewards, such as reward points, cash back, airline miles, or the like, by using that payment card to engage in transactions, and the account database 166 keeps track of the earned financial rewards. In some arrangements, the account database 166 also stores and allows access to financial reward preference information for various users in the form of various financial reward profiles that will be described in greater detail below.

The rewards offer database 168 is structured to store content used by the reward offer distribution system 156 to generate financial reward offers for delivery to the customer 110, and may include non-transient data storage mediums (e.g., local disc or flash-based hard drives, local network servers, and the like) or remote data storage facilities (e.g., cloud servers). In some arrangements, the reward offer content database 168 includes information that identifies a plurality of merchants at which customers can earn and redeem financial rewards. Identified merchants may include, for example, brick and mortar store locations, or online merchants. In one embodiment, reward offer components stored in the reward offer database 168 also includes information that identifies specific products (and their associated costs) that customers can purchase through the redemption of earned financial rewards or that customers may purchase to earn financial rewards. In some arrangements, reward offer components also include information that identifies the amount of financial rewards that customers will earn or redeem by engaging in transactions at various merchants (e.g., earn 2× rewards at Merchant A). In one embodiment, the amount of financial rewards redeemed or earned depends on the value of the transaction that the customer engages in when taking advantage of a financial reward offer (e.g., spend $100 to earn 100 points at Merchant B).

In some arrangements, the reward offer content stored in the reward offer database 168 also includes pre-assembled financial reward offers that enable customers to either earn financial rewards using a payment account associated with the rewards account or to redeem financial rewards already earned by the customer 110. The reward offers may take any one of a variety of forms, including audio, video, text messages, phone calls, digital images, text-based documents, and the like. In some arrangements, the pre-assembled reward offers contain merchant-identifying information, a target transaction (e.g., information identifying a product to be purchased and a typical price for the identified product), and a reward amount (e.g., an amount of reward “points” that a customer may earn by taking advantage of the offer or an amount of reward “points” that the customer has to burn to receive the identified product).

In some arrangements, the financial reward offer content stored in the rewards offer database 168 is stored based on the nature of the content or offer. For example, each merchant or product stored in the reward offer database 168 may be stored in association with a particular topic or set of topics, thus creating topic-based subdivisions within the reward offer database 168. In some embodiments, the particular “topics” include product categories that customers may post about on social media. For example, reward offer content related to a sporting goods merchant may be stored in a “sporting goods” subdivision of the reward offer database 168. This way, the reward offer distribution system 156 can efficiently retrieve sporting goods reward offer content responsive to a customer 110 posting a communication on social media relating to sporting goods.

In some arrangements, the topics that the financial reward offers are stored in relation to also include various events (e.g., triggering events) that may or may not be applicable to the customer. These triggering events may include events that are typically associated with elevated customer spending or events that are likely to coincide with the customer earning and redeeming financial rewards. These events may include, for example, birthdays, anniversaries, marriages, purchasing a home, gaining new employment, having a child, and the like. In some arrangements, triggering events may also include certain topics about which the customer 110 may post on social media (e.g., regarding certain products, travel destinations, financial goals, and the like).

In some arrangements, triggering events may also include various financial goals of customers (e.g., savings goals, purchasing goals, investment goals, and the like). In one embodiment, reward offer content is stored such that it is associated with financial goals that the reward offer content is designed to help customers achieve. For example, reward offer content that enables the customer to earn financial rewards by opening up a savings account at the financial institution may be stored in association with a “savings” financial goal. As will be described in greater detail below, responsive to the detection of a triggering event (or a social media communication that is related to a triggering event), the reward offer distribution system 156 is configured to deliver a reward offer stored in association with that triggering event to the customer 110. Thus, if a customer 110 posts information concerning a financial goal (e.g., travelling to Europe) on social media, the reward offer distribution system 156, is configured to generate a reward offer that is configured to facilitate the customer 110 achieving that goal (e.g., “you have earned enough reward points to purchase x % of a flight to London”).

The reward offer database 168 may also include pooling reward offers. As will be described below, pooling reward offers provide customers the opportunity to either invite acquaintances (e.g., social media connections) to pool their financial rewards to the benefit of the customer 110, or provide the customer 110 with the opportunity to put any financial rewards that the customer 110 has earned towards a social media connection of the customer 110. These pooling reward offers may be stored in association with certain life-events that typically coincide with people giving gifts to one another, such as birthdays, holidays, anniversaries, and the like. Pooling reward offers, for example, identify a transaction that pooled financial rewards will be used for. In some embodiments, pooling reward offers are stored in association with a financial goal or milestone that each pooling reward offer is configured to help the customer 110 achieve.

The customer social media database 170 is a storage device that is structured to retrievably store customer information related to various operations discussed herein, and may include non-transient data storage mediums (e.g., local disc or flash-based hard drives, local network servers, and the like) or remote data facilities (e.g., cloud servers). In some embodiments, the customer social media database 170 includes personal customer information (e.g., names, addresses, phone numbers, and so on), identification information, and customer social media account information (e.g., customer social media activity information, information that the customer has communicated over the network 180 to other users of the social media platform, customer profile information, and the like).

The reward offer distribution system 156 is configured to manage a financial reward program for a customer. In this regard, the reward offer distribution system 156 is configured to receive information input by the customer 110 into the customer device 112, retrieve other customer information stored in the account database 166 and customer social media database 170, identify financial reward offers that are applicable to the customer 110, monitor customer social media usage to determine appropriate reward offers to deliver to the customer 110, and communicate appropriate reward offers to the customer device 112. Accordingly, the reward offer distribution system 156 is communicatively coupled with the network interface 154, the account database 166, the reward offer database 168, and the customer social media database 170.

As shown, the reward offer distribution system 156 includes profile generation circuit 158, social media monitoring circuit 160, offer creation circuit 162, and reward pooling circuit 164. Further, in some arrangements, activities of one circuit may be combined with the activities of another circuit, thus, the depiction and explanation contained herein is for exemplary purposes only.

The profile generation circuit 158 is configured to generate a financial reward profile for the customer 110. The financial reward profile includes a set of reward preferences and a set of triggering events for the customer 110. Reward preferences may identify, for example, preferred merchants for the customer 110 to earn or redeem financial rewards, transaction amount thresholds (e.g., transaction amounts that the customer 110 is likely to engage in), particular products that the customer 110 would like to purchase, and the like. In some arrangements, these reward preferences may be determined based on customer preferences input during a registration process to be described in greater detail below. In some embodiments, the reward preferences are generated based on customer information (e.g., age, family status, income level, wealth, etc.) stored in the account database 166. Certain reward offers involving transactions above a certain monetary threshold, for example, may be ruled out for the customer 110 based on the financial reward-earning history of the customer 110. The reward preferences for the customer 110 may also be generated based on historical information stored in the account database 166. For example, the profile generation circuit 158 may select reward preferences for the customer 110 that are used by other customers having similar information to the customer 110.

In some arrangements, information stored in the customer social media database 170 is also taken into account to generate customer reward preferences. For example, in some arrangements, the profile generation circuit 158 is configured to retrieve customer social media information (e.g., regarding past communications, social media connections, account settings, and the like) stored in the customer social media database 170 to determine whether that information is indicative of any reward preferences of the customer 110. In some arrangements, the profile generation circuit 158 determines if the customer 110 tends to communicate about particular topics that are related to spending habits and incorporate any spending habits of the customer 110 into the financial reward profile. To illustrate, if a particular customer consistently posts about a particular restaurant on social media, the profile generation circuit 158 identifies that restaurant and includes that restaurant, and potentially similar restaurants, in the customer's financial reward profile (e.g., as merchant at which the customer prefers to earn or redeem financial rewards). In some arrangements, the profile generation circuit 158 is configured to periodically assess the information stored in the customer social media database 170 and update the financial reward profile for the customer 110 if new customer preferences are indicated by customer social media usage and/or financial activity.

In some arrangements, the profile generation circuit 158 is configured to generate triggering events based at least in part on customer reward preferences discussed above. For example, if financial reward preferences of the customer 110 indicate that the customer 110 has a preference for earning and redeeming financial rewards at restaurants, the set of triggering events included in the financial reward profile may include a plurality of topics or events that are related to restaurants (e.g., weekend nights, travelling, and the like). In some arrangements, triggering events are also generated based on customer information in similar ways discussed above in relation to the customer preferences.

In some arrangements, the set of triggering events produced for the customer 110 also includes financial goals or milestones of the customer 110. For example, during the registration process, the customer 110 may indicate that they have certain financial goals (e.g., buying a home in the near future, saving for children's college tuition, retirement, purchasing a car, or the like). Additionally, the profile generation circuit 158 is also configured to generate a set of financial goals for the customer 110 based on information concerning the customer (e.g., customer age, customer financial account information, customer family status, and the like) stored in the account database 166 or the customer social media database 170. To illustrate, if information concerning the customer 110 stored in the account database 166 indicates that the customer 110 is in their early twenties, the profile generation circuit 158 is configured to set gaining full time employment as a triggering event as well as to set savings goals (e.g., threshold savings amounts that the customer 110 should have in an account at certain times) for the customer.

In some arrangements, customer financial milestones are events that are indicative of the customer 110 taking steps towards achieving a financial goal. In some arrangements, the financial milestones included in the financial reward profile of the customer are related to the financial goals included in the profile. For example, if a particular customer indicates a financial goal of buying a new car, then the customer selling an old car would be a financial milestone for the customer. In some arrangements, customer financial milestones may include other events that signify customer financial health, such as the paying off of loans, obtaining employment, improvements in the physical health of the customer, educational achievements, and the like.

The social media monitoring circuit 160 is configured to monitor customer social media usage to determine appropriate reward offers to deliver to the customer 110. Accordingly, the social media monitoring circuit 160 is configured to receive customer social media usage data describing customer interactions with the social medial client application 118 transmitted by the customer device 112 and/or the social media computing system 142. The social media monitoring circuit 160 is further configured to determine at least one characteristic of the customer interactions with the social media client application 118 to facilitate the delivery of an appropriate reward offer to the customer. For example, if the customer interaction is a message sent to other users of a social media platform, social media monitoring circuit 160 may be configured to perform a textual analysis on the message to determine the topic of the message. To illustrate, the customer 110 may input a message into the social media client application 118 such as “I cannot wait to go on a vacation to destination X!” The social media monitoring circuit 160 may be configured to receive this message, and determine that the customer is interested in going to the indicated destination.

The social media monitoring circuit 160 is also configured to determine if any received customer social media usage information is related to any of the topics or triggering events contained in the generated customer financial reward profile. Accordingly, the social media monitoring circuit 160 is communicably coupled to the account database 166. To illustrate, if the customer 110 receives a “happy birthday” message from a social media connection via a social media platform, the social media monitoring circuit 160, upon receiving an indication of this message over the network 180, is configured to identify that it is the customer's birthday based on the text of the message. Having detected a triggering event, the social media monitoring circuit 160 is further configured to retrieve financial reward offers from the reward offer database 168 that are consistent with the reward preferences contained in the generated customer financial reward profile. Accordingly, the social media monitoring circuit 160 is communicably coupled to the reward offer database 168. To illustrate, if the customer 110 in the birthday example discussed above has a financial reward preference for sporting goods merchants, the social media monitoring circuit 160 is configured to retrieve or generate a reward offer that notifies the customer 110 that the customer 110 can redeem financial rewards by engaging in a transaction at an identified sporting goods merchant.

In some arrangements, the social media monitoring circuit 160 is also configured to monitor customer social media usage information for occurrences that are indicative of events related to customer financial goals or milestones. For example, in one embodiment, the social media monitoring circuit 160 is configured to analyze the content of any customer social media communications (e.g., stored in the customer social media database 170 or received from the customer device 112) to determine if any of the communications are related to a financial goal contained in the customer's financial reward profile discussed above (e.g., the purchasing of a home, paying off of a loan, etc.). Responsive to a detection that the customer 110 has posted a communication concerning a financial goal or milestone, the reward offer distribution system 156 is configured to initiate a sequence to deliver financial reward offers to the customer that are associated with the detected financial goal or milestone.

In various arrangements, the social media monitoring circuit 160 is also configured to determine when it is appropriate to deliver a pooling rewards offer to the customer 110. In some arrangements, this determination may be based on information stored in the account database 166. For example, during a registration process for the financial reward program, the customer may have indicated a privacy preference that they do not wish to participate in the pooling of reward offers. In some arrangements, the social media monitoring circuit 160 is configured to determine whether received customer social media is indicative of an event that historically been associated with gift-giving (e.g., birthdays, weddings, children, and the like). To illustrate, if the customer 110 (by, e.g., interacting with the social media client application 118 of the customer device 112) creates a housewarming party event and invites various social media connections to the event, the social media monitoring circuit 160 is configured to identify that the customer 110 is going through a particular triggering event (e.g., a recent home purchase), identify that the triggering event is appropriate for reward pooling, and to initiate processes for social media connections of the customer 110 pooling their financial rewards to purchase a housewarming gift for the customer 110 using processes that will be described in greater detail below.

The offer creation circuit 162 is configured to generate financial reward offers to be delivered to the customer 110 based on the received customer information and the information stored in the account database 166, reward offer database 168, and customer social media database 170. In some arrangements, responsive to the social media monitoring circuit 160 determining that the customer has communicated information pertaining to a certain event or topic (e.g., a triggering event), the offer creation circuit 162 is configured to generate a financial reward offer to be delivered to the customer 110 based on the detected event or topic. This includes, for example, retrieving reward offer components (e.g., merchant identification information, product identification information, and the like) from the reward offer database 168 that are consistent with the customer's financial reward profile and the detected event or topic, retrieving customer financial reward information (e.g., a financial reward balance associated with a rewards account held by the customer 110), and assembling this information into financial reward offer content for delivery to the customer 110. Accordingly, the offer creation circuit 162 is communicably and operatively coupled to the account database 166, reward offer database 168, customer social media database 170, and social media monitoring circuit 160 to perform these functions. Financial reward offer content may be configured to present the customer 110 with a graphical interface on the customer device 112 depicting a merchant as well as transaction characteristics. The transaction characteristics may identify, for example, the amount of financial rewards that are to be redeemed or earned, a transaction amount, and an object to be purchased.

In some arrangements, offers generated by the offer creation circuit 162 are configured to facilitate the customer 110 accomplishing a financial goal or milestone. For example, if the customer 110 posts a communication concerning a financial goal in the customer's financial reward profile, the offer creation circuit 162 is configured to retrieve financial reward content stored in the reward offer database 168 that is geared toward accomplishment of that financial goal. To illustrate, if the customer 110 posts a communication on social media regarding a desire to travel to a particular destination, the offer creation circuit 162 is configured to retrieve customer reward balance information from the account database 166, retrieve reward offer content stored in the reward offer database 168 that is related to the destination (e.g., information concerning merchants, like hotels, flights, touring companies, and the like), and generate a reward offer for delivery to the customer, indicating that the customer 110 may use earned financial rewards to cover at least part of the cost of travelling to the destination, or earn financial rewards by making certain travelling arrangements.

In some arrangements, the offer creation circuit 162 is also configured to generate pooling reward offers to be delivered to the customer 110 or social media connections of the customer 110. Pooling reward offers are generated in a similar manner to the reward offers discussed above, except that pooling offer may include additional content. This additional content, for example, provides the customer 110 with the ability to indicate whether they wish to invite social media connections to pool financial rewards to benefit the customer 110. Additionally, when pooling reward offers are transmitted to computing devices associated with the social media connections of the customer 110, for example, the pooling reward offers may also include information identifying the customer 110 and information identifying the circumstances of the customer 110 (e.g., the triggering event) that led to the reward pooling offer.

The reward pooling circuit 164 is structured to transmit and receive information that enables either the customer 110 or customer social media connections to pool financial rewards. In some arrangements, responsive to the customer 110 (for example, in a pooling reward offer selected by the offer creation circuit 162) indicating a preference to invite social media connections to pool their financial rewards to the benefit of the customer 110, for example, the reward pooling circuit 164 may be configured to retrieve information from the customer social media database 170 to identify social network connections of the customer 110 that are also registered for a reward offer program with the financial institution 150. Additionally, the reward pooling circuit 164 may also be configured to retrieve any information regarding financial rewards that the identified social network connections have earned from the account database 166, and transmit pooling reward offers to any customer devices 112 associated with identified social network connections that have financial rewards available over the network 180. In some arrangements, the reward pooling circuit 164 is also configured to receive any responses to the transmitted reward pooling offers, determine the amount of financial rewards that were pooled, and deliver financial reward to the customer 110.

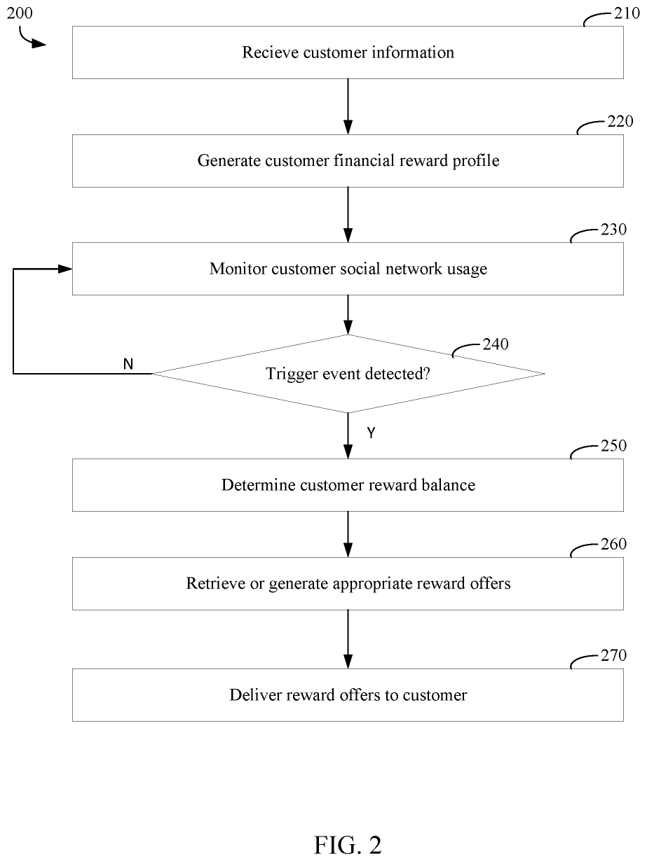

Referring now to FIG. 2, a flow diagram of a method 200 of delivering reward offers to a customer 110 of the financial institution 150 that is also a user of a social media platform is shown according to an example embodiment. The method 200 may be performed by the components of FIG. 1, such that reference may be made to one or more components of FIG. 1 to aid description of the method 200. It should be understood that initiation of the method 200 may take a variety of forms. For example, in one arrangement, the method 200 is initiated responsive to a preference input into the customer I/O device 116 on the customer device 112.

Customer information is received at 210. In various arrangements, the financial institution computing system 152 may receive information from a variety of sources over the network 180. In some arrangements, the received information includes social media data that was recently communicated by the customer 110 (through, e.g., the social media client application 118) to the social media computing system 142 over the network 180 so that the data is visible on a social media platform. In some arrangements, this information is received from the customer device 112, which may include an API that configures the social media client application 118 to transmit information pertaining to customer interactions with the social media client application 118 to the financial institution computing system 152. In some arrangements, the received information includes information communicated by the social media computing system 142 over the network 180, and may include information pertaining to a social media account held by the customer 110.

In some arrangements, the received information includes information input by the customer 110 into a registration interface presented to the customer 110 via the financial institution client application 120 of the customer device 112. In certain arrangements, the financial institution computing system 152 may be configured to transmit content (e.g., a web page) to the customer device 112 that gives the customer the ability to indicate a preference to register for the financial reward delivery program discussed herein. This transmitted content is presented to the user via the customer I/O device 116 (while, e.g., the customer device 112 is implementing the financial institution client application 120), and also provide the customer with the ability to indicate various preferences as to the types of reward offers that they would like to receive. These preferences include, for example, the types of merchants at which the customer would like to earn or use financial rewards, the frequency with which the customer is to receive financial reward offers, whether the customer wishes to be involved in pooling reward offers, and so on. The transmitted content to the customer may also include financial goal information of the customer 110.

A customer financial reward profile is generated at 220. In some arrangements, based on the customer information received at 210, the reward offer distribution system 156 determines which type of financial reward offers to deliver to the customer. As discussed above, this includes generating a set of reward preferences and triggering events for the customer 110.

Customer social media usage is monitored for triggering events at 230 and 240. In some arrangements, the reward offer distribution system 156 receives customer social media information over the network 180 from either the customer device 112 or the social media computing system 142 and determines a characteristic of the received social media information. In some arrangements, the determining of the characteristic includes determining if the received information is indicative of any of the triggering events in the financial reward profile of the customer. In some arrangements, if a triggering event is not detected, the reward offer distribution system 156 continues to monitor customer social network usage at 230.

If a triggering event is detected (e.g., the customer posts about a particular topic, financial goal, or life event), a customer financial reward balance is determined at 250. In some arrangements, the reward offer distribution system 156 is configured to retrieve a customer reward balance from the account database 166.

Reward offers are generated or retrieved at 260. In some arrangements, the reward offer distribution system 156 is configured to retrieve reward offer content stored in the reward offer database 168 to generate a reward offer. The reward offer is generated based on the identity of the triggering event identified to have occurred in relation to the customer or a topic of a recent customer social media communication. For example, if the received social media information indicates that the customer has reached a financial milestone, the reward offer distribution system 156 is configured to retrieve reward offer content that is related to the financial milestone. To illustrate, if the customer has just purchased a new home, then the reward offer distribution system 156 may select reward offer content stored in a home purchasing subdivision of the reward offer database 168 to generate reward offers to deliver to the customer. Generated reward offers enable the customer to earn or redeem financial rewards by engaging in transactions at merchants having products commonly purchased upon moving, such as furniture, appliances, and the like.

In some arrangements, if the received customer social media usage information indicates a customer financial goal, the reward offer distribution system 156 is configured to generate a financial reward offer that facilitates the customer achieving that financial goal. For example, if the reward offer distribution system 156 (by, e.g., the social media monitoring circuit 160) determines that the customer 110 has a goal to purchase new furniture, the reward offer distribution system 156 is configured to generate a financial reward offer that enables the customer 110 to earn or redeem financial rewards at merchants selling furniture. In some arrangements, responsive to detecting a financial goal of the customer 110, the reward offer distribution system 156 is configured to generate reward earning offers that enable the customer 110 to earn rewards that can later be used to accomplish the financial goal. In the furniture example discussed above, the reward offer distribution system 156 is configured to generate reward earning offers that are associated with merchants that are in accordance with customer reward preferences (e.g., a merchant that the customer 110 commonly shops at).

In some arrangements, the reward offer distribution system 156 is configured to generate reward offers that are related to recent social media communications of the customer 110. For example, if the customer 110 posts on social media regarding a new pet, the reward offer distribution system 156 is configured to identify merchants stored in the reward offer database 168 that have products related to pet care, and generate a financial reward offer that either allows the customer to earn or burn financial rewards by engaging in a transaction at that merchant. The reward offer distribution system 156 assembles the merchant identifying information retrieved at 260, customer financial reward balance information, and transaction information into a graphical interface to be presented to the customer 110.

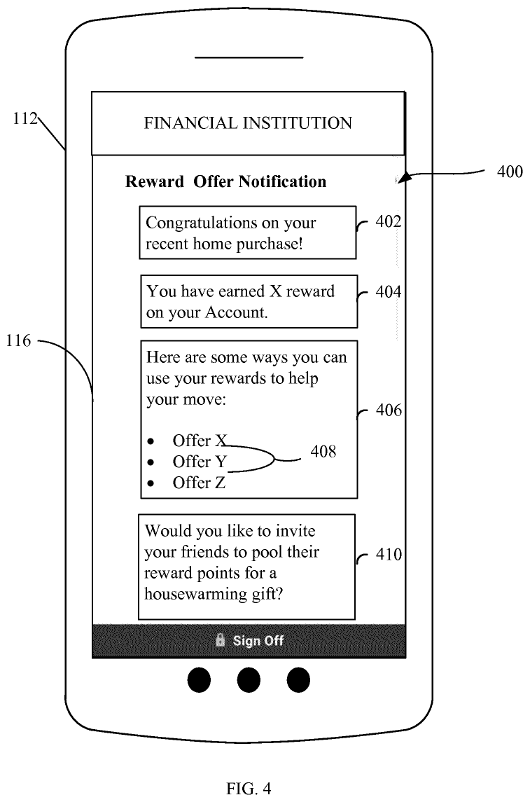

Reward offers are delivered to the customer 110 at 270. In some arrangements, the reward offers take the form of content that is communicated by the reward offer distribution system 156 to the customer device 112 over the network 180 via the network interface 154. In some arrangements, the reward offer is a graphical interface viewable on the customer device 112 by implementing the financial institution client application 120. An example reward offer interface will be discussed below in relation to FIG. 4.

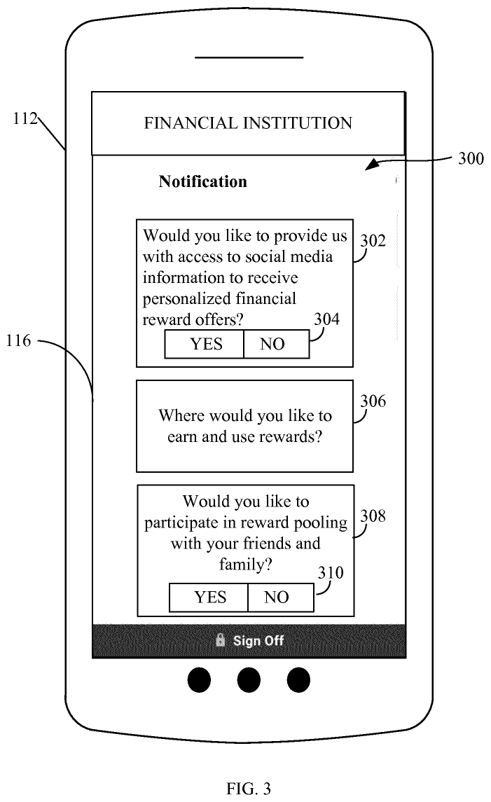

Turning now to FIG. 3, an example interface 300 displayed by the customer device 112 is shown. The interface 300 may be similar to the registration interface discussed above. The interface 300 is presented to the user via a customer I/O device 116 on a customer device 112, and includes a program notification window 302, a rewards preferences window 306, and a pooling preferences window 308. The program notification window 302 identifies the financial reward program to the customer 110 and provides the customer 110 with a preference button 304, giving the customer the ability to indicate a preference to register for the program. If the customer 110 indicates a preference to register for the program, this is communicated to the financial institution computing system 152 over the network 180 via the network interface 114. Responsive to this notification, the financial institution computing system 152 may be configured to transmit an API to the customer device 112 that configures the customer device 112 to transmit customer social media usage information to the financial institution computing system 152.

The rewards preferences window 306 provides the customer 110 the ability to indicate preferences as to the kind of reward offers that they would prefer to receive. These preferences may identify, for example, the types of merchants at which the customer 110 wishes to earn or spend financial rewards, transaction amount preferences, and the like. Upon selecting the rewards preferences window 306, the customer 110 may be presented with a merchant-type list, enabling the customer the ability to indicate whether they would like to receive financial reward offers relating to a particular type of merchants. In some arrangements, the rewards preferences window 306 enables the customer to input financial goal information. Any information input by the customer into the rewards preference window is transmitted to the financial institution computing system 152 over the network 180. The pooling preferences window 308 gives the customer 110 the ability to indicate whether they wish to participate in reward pooling. Reward pooling may enable social media connections of the customer 110 to pool their financial rewards to benefit the customer.

Referring now to FIG. 4, an example reward offer interface 400 displayed by the customer device 112 is shown. The interface 400 is presented to the user via a customer I/O device 116 on a customer device 112, and, as shown, includes a triggering event identification window 402, a reward balance window 404, a reward offer window 406, and pooling offer window 410. The triggering event identification window 402 presents the customer 110 with the triggering event that led to the presentation of a financial reward offer. For example, as displayed in FIG. 4, if the financial institution computing system 152 detects that the customer 110 has just purchased a home, the reward offer transmitted to the customer 110 may include a congratulatory statement 402 regarding that home purchase. The reward balance window 404 indicates a value of financial rewards that the customer has earned. In some situations where, for example, the customer 110 has multiple payment accounts with the financial institution 150 and has earned multiple financial rewards, the reward balance window may include multiple reward balances. The reward balances may take the form of the financial rewards earned by the customer, such as, reward points, cash back, airline miles, and the like. The reward offer window 406 presents the customer with at least one reward offer 408 that is relevant to the identified triggering event. The reward offers 408 may include both opportunities to earn reward points by engaging in transactions, as well as opportunities to spend already-earned financial rewards by using them towards identified transactions. In some arrangements, the reward offers 408 are selectable by the customer 110 via the customer device 112. For example, the customer 110 may select a particular offer 408 by tapping the screen in a corresponding position. If the customer 110 selects an offer, the customer 110 may be presented with another interface that gives the customer the opportunity to accept the offer by allocating at least a portion of the earned financial rewards identified in the reward balance window 404 towards an identified transaction.

The pooling offer window 410 gives the customer 110 the ability to indicate a preference to invite connections to pool their financial rewards for the customer 110. In some arrangements, upon selecting the pooling offer window 410, the customer 110 may be brought to another interface, giving the customer the ability to identify a preferred transaction that the customer 110 wishes the connections to pool their financial rewards towards.

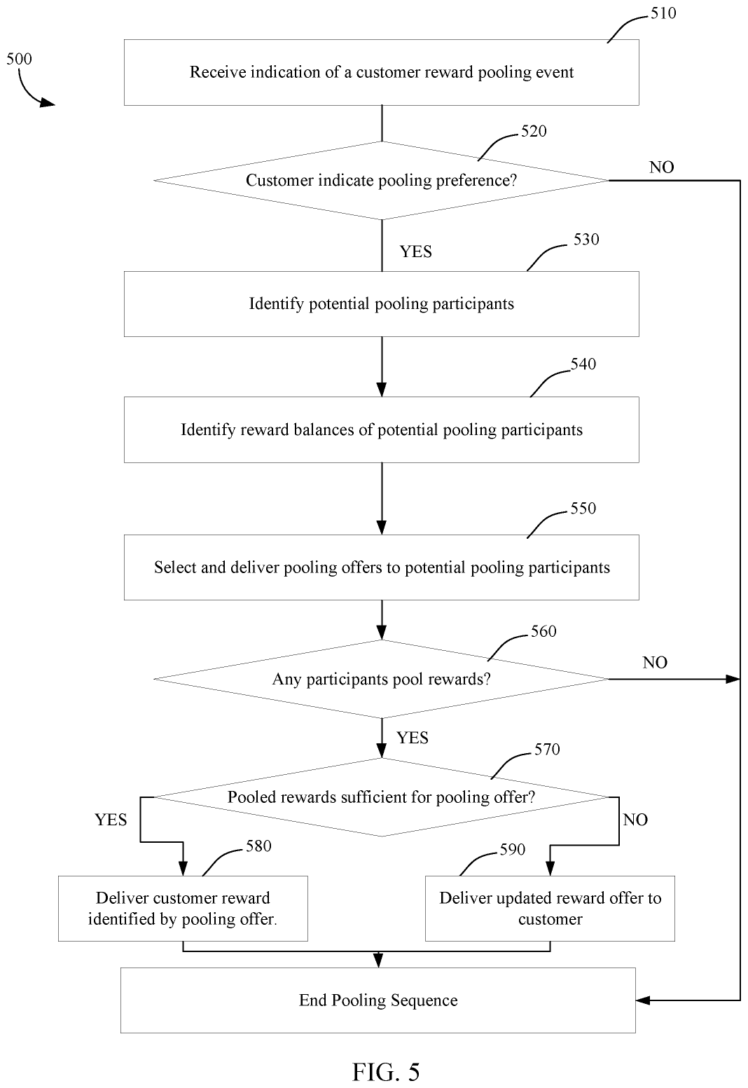

Referring now to FIG. 5, a flow diagram of a method 500 of enabling social network connections to pool financial rewards to benefit a customer 110 of the financial institution 150 that is also a user of a social media platform is shown according to an example embodiment. The method 500 may be performed by the components of FIG. 1, such that reference may be made to one or more components of FIG. 1 to aid description of the method 500.

A customer reward pooling event is detected at 510. In some arrangements, the reward offer distribution system 156 receives social media data concerning the customer 110 and determines (e.g., by the social media monitoring circuit 160) that this received data is indicative of a triggering event that is associated with reward pooling (e.g., indicative of a customer preference to receive gifts). Upon detection of a reward pooling event, in some arrangements, the reward offer distribution system 156 is configured to (by, e.g., the offer creation circuit 162) retrieve appropriate reward pooling offer content stored in the reward offer database 168 to be presented to the customer 110 (via, e.g., the customer device 112). In some arrangements, upon detection of a reward pooling event, the reward offer distribution system 156 is configured to retrieve information concerning a customer social media account from the customer social media database 170.

It is determined if the customer 110 indicated a reward pooling preference at 520. In some arrangements, the financial institution computing system 152 receives any responses input by the customer 110 into pooling reward offers transmitted to the customer at 510 to determine if the customer 110 indicated a reward pooling preference. In some arrangements, the reward offer distribution system 156 may be configured to retrieve customer pooling preference information stored in the account database 166. In some arrangements, if the customer 110 has indicated a preference not to participate in reward pooling, the pooling sequence 500 ends.

In some arrangements, the reward offer distribution system 156 skips the step 520 discussed above. For example, responsive to receiving an indication of a customer reward pooling event at 510, the reward offer distribution system 156 is configured to retrieve information concerning a customer social media account from the customer social media database 170 so as to perform the method steps below, without transmitting any pooling reward offers to the customer 110. This way, the reward offer distribution system 156 may surprise the customer 110 by delivering pooled financial rewards to the customer 110 by performing the steps described below.

Potential pooling participants are identified at 530. In some arrangements, the reward offer distribution system 156 (via, e.g., the reward pooling circuit 164) is configured to retrieve information concerning social media connections of the customer from the customer social media database 170. In some arrangements, the reward offer distribution system 156 is configured to assess the social network information to identify the social media connections of the customer 110 and determine whether those connections are also registered for the financial reward program by searching information stored in the account database 166. In some arrangements, the potential pooling participants may be further narrowed to only include the social media connections that are closest to the customer (e.g., immediate family, the social media connections that the customer 110 follows or interacts with the most on the social media platform, etc.).

Financial reward balances of the potential pooling participants are determined at 540. In some arrangements, the reward offer distribution system 156 is configured to retrieve this information from the account database 166.

Pooling reward offers are selected and delivered to the potential pooling participants at 550. In some arrangements, the reward offer distribution system 156 (via, e.g., the offer creation circuit 162) is configured to select a pooling reward offer stored in the reward offer database 168 to be transmitted to the potential pooling participants based at least in part on any input received from the customer 110. In some arrangements, the reward offer distribution system 156 is configured to select a pooling reward offer based on the initial pooling triggering event detected at 510 as well as the number of identified potential pooling participants. For example, if it is detected that the customer 110 has a particular financial goal, the reward offer distribution system 156 is configured to generate reward pooling offers that enable the pooling participants to help the customer 110 achieve the financial goal. For example, if the customer 110 indicates a financial goal of travelling to a particular destination, the generated pooling reward offers may enable the social media connections of the customer 110 to pool financial rewards towards at least a portion of the customer's flight to that destination. In other arrangements, the pooling reward offers selected enable the potential pooling participants to select (or vote) on the particular financial reward that they wish to put their financial rewards towards.

Once reward pooling offers are generated, they are delivered to the potential pooling participants. In some arrangements, the reward offers take the form of content that is transmitted to customer devices 112 associated with the potential pooling participants. The reward offer distribution system 156 communicates the content over the network 180 to the customer devices 112 via the network interface 154. In some arrangements, the content takes the form of a pooling reward offer graphical interface that gives the potential pooling participants the ability to indicate a preference to pool at least a portion of their financial rewards to the customer 110. An example pooling reward offer graphical interface will be discussed in greater detail below in relation to FIG. 7.

It is determined if any pooling participants chose to pool rewards at 560. In some arrangements, the reward offer distribution system 156 is configured to receive any responses from potential pooling participants. If none of the potential pooling participants indicated a preference to pool financial rewards within a predetermined period, for example, the pooling sequence 500 ends.

The amount of pooled rewards is determined at 570. In some arrangements, the reward offer distribution system 156 (via, e.g., reward pooling circuit 164) is configured to aggregate all of the financial reward amounts indicated by the potential pooling participants to determine if enough rewards have been pooled to complete the target transaction identified by the pooling reward offer.

If the pooled financial rewards are enough to complete the transaction identified by the reward pooling offer, then the transaction is completed on behalf of the customer at 580. In some arrangements, the reward offer distribution system 156 (via, e.g., the reward pooling circuit 164) is configured to transact with a merchant for a product identified by the reward pooling offer and arrange for that product to be shipped to the customer 110 using customer information stored in the account database 166. Once the transaction has been completed, the financial institution computing system 152 may also be configured to update the account information in the account database 166 of the potential pooling participants (e.g., update financial rewards balances) who pooled financial rewards.

If not enough financial rewards were pooled to complete the identified transaction, an updated reward offer may be delivered to the customer at 590. This updated reward offer may be similar to that which was presented during the customer during the process discussed above in relation to FIG. 2, with some minor differences. In some arrangements, if not enough financial rewards were pooled to complete a target transaction identified by the pooling reward offer, the financial institution computing system 152 is configured to update the financial reward balance of the customer 110 to reflect the amount of financial rewards pooled by the social network connections. Accordingly, the updated financial reward offer transmitted to the customer 110 may include an updated financial reward balance, and also identify the social media connections who pooled their financial rewards. In other arrangements, the updated reward offer delivered to the customer may be updated to reflect the pooled financial rewards. For example, the reward offer may provide the customer 110 with an opportunity to purchase a particular product for an identified amount of reward points. This identified amount of reward points may be decreased by the amount of reward points pooled by the social media connections, so that the customer 110 may complete the identified transaction using less reward points of the customer 110.

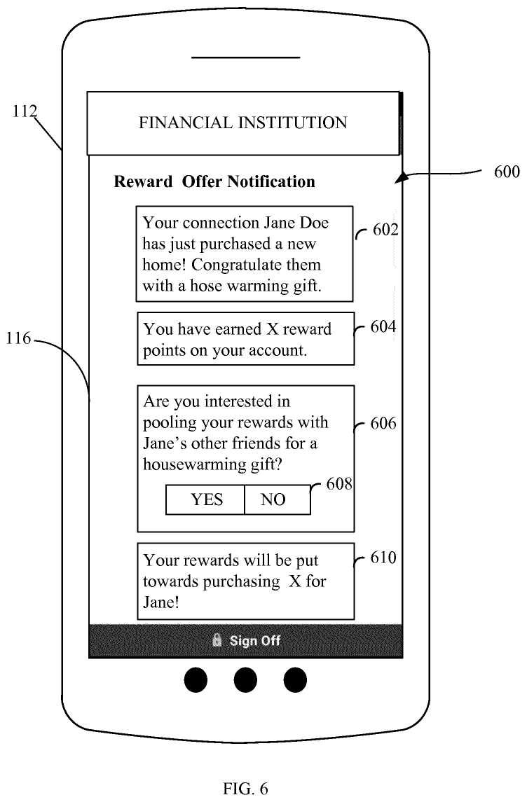

Referring now to FIG. 6, an example interface 600 displayed by a customer device 112 is shown. The interface 600 may be presented to social media connections of the customer 110 during the method 500 discussed above in relation to FIG. 5. The interface 600 is presented to a social network connection of the customer 110 via a customer I/O device 116 on a customer device 112, and, as shown, includes a customer identification window 602, a reward balance window 604, a pooling preference window 606, and a reward offer window 610. The customer identification window 602 identifies the customer 110 and the triggering event that has occurred in relation to the customer 110. The reward balance window 604 notifies the social network connection of any financial awards that they have earned by using a payment account at the financial institution 150. The pooling preference window 606 requests the customer to indicate whether they wish to pool any earned financial rewards towards the customer 110. The pooling preference window 606 includes a preference indication button 608 that enables the customer to indicate whether they wish to pool their financial rewards. If the social media connections presses the preference indication button 608 in a way that indicates that they wish to pool financial rewards, the social media connection may be brought to another screen that gives the social media connection the ability to indicate what portion of earned financial rewards that they wish to allocate to the customer 110.

The reward offer window 610 identifies how any pooled financial rewards may be used to benefit the customer 110. In some arrangements, the reward offer window 610 identifies a target transaction, such as purchasing a specific product for the customer 110. In other situations the reward offer window 610 may identify a plurality of potential transactions, and the social media connection may choose how they wish to use earned financial rewards to benefit the customer.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U. S. C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system associated with a financial institution, the system comprising:
a customer database configured to store customer information for a customer of the financial institution, wherein the customer uses a social media account associated with a social media company, wherein the social media account is associated with a social media account database storing customer social media information; and
a processing circuit comprising a processor and memory, the memory structured to store instructions that are executable by the processor and cause the processing circuit to:
receive social media information concerning social media usage of the customer from the social media account database, the social media information comprising customer social media activities and customer communications over social media associated with the social media account, the customer communications directed to one or more users of the social media company;
store the social media information in the customer database;
perform textual analysis on content of the customer communications of the received social media information to determine whether the content is indicative of a gift-giving event;
responsive to determining that the content is indicative of a gift-giving event, retrieve financial reward offer content from a reward offer database to be delivered to the customer, the financial reward offer content related to the gift-giving event; and
transmit the financial reward offer content to a customer device associated with the customer, wherein the financial reward offer content is transmitted over a network, and wherein the financial reward offer content gives the customer the ability to indicate a preference to invite social media connections associated with the customer and with the financial institution to pool financial rewards points of the social media connections toward the financial reward offer to provide a gift to the customer.

2. The system of claim 1, wherein the processing circuit is further caused to:
determine a characteristic by performing the textual analysis, wherein the determined characteristic includes a topic of a message sent by the customer to the one or more users of the social media company;
create a topic-based subdivision within the reward offer database based on the determined characteristic; and
store the reward offer content related to the determined characteristic in the topic-based subdivision.

3. The system of claim 1, wherein the processing circuit is further caused to:
receive customer information manually entered into the customer device;
retrieve financial account information of the customer from the customer database; and
generate a financial reward offer profile for the customer based on at least one of the received customer information and the retrieved financial account information from the customer database, the financial reward profile including at least one customer financial reward preference and at least one triggering event.

4. The system of claim 3, wherein the financial reward preference identifies at least one of a merchant at which the customer would prefer to earn and redeem a financial reward and a transaction amount threshold.

5. The system of claim 3, wherein the at least one triggering event identifies a potential circumstance or communication topic of the customer.

6. The system of claim 5, further comprising determining a characteristic by performing the textual analysis, wherein determining of the characteristic includes determining if the received social media information is indicative of a triggering event contained in the generated financial reward offer profile.

7. The system of claim 5, wherein the at least one triggering event identifies a customer financial goal.

8. The system of claim 5, wherein the processing circuit is further caused to:
retrieve reward offer content from the reward offer database based on the generated reward offer profile.

9. The system of claim 2, wherein determining the characteristic includes determining that the received social media information is indicative of a customer preference to receive a gift, and the transmitted reward offer content includes a first graphical interface that gives the customer the ability to indicate a preference to invite the social media connections to pool financial rewards points.

10. The system of claim 9, wherein the processing circuit is further caused to:
receive an indication of a customer preference to invite the social media connections to pool financial rewards points;
retrieve information associated with the social media connections from the customer database;
determine a financial reward balance for each of the social media connections;
retrieve reward offer content from the reward offer database to be delivered to the social media connections based on the customer preference to receive a gift; and
transmit the reward offer content to a plurality of computing devices associated with the social media connections, the transmitted reward offer content including a second graphical interface that gives the social media connections the ability to indicate a preference to pool financial rewards points to benefit the customer.

11. The system of claim 10, wherein the processing circuit is further caused to:
receive a preference to pool financial rewards points to benefit the customer from at least one computing device associated with at least one social media connection, the preference to pool financial rewards points indicating a pooling amount; and
deliver a financial reward to the customer, the amount of the delivered financial reward being based on the pooling amount.

12. The system of claim 1, wherein the delivering of the financial reward to the customer includes at least one of performing a transaction on behalf of the customer and updating a customer reward balance in the customer database.

13. A computer-implemented method comprising:
receiving, by a financial institution computing system, social media information concerning a customer, the social media information comprising customer social media activities and customer communications over social media, the customer communications directed to one or more users of social media;
storing the social media information in the customer database;
performing, by the financial institution computing system, textual analysis on content of the customer communications of the received social media information to determine whether the content is indicative of a gift-giving event;
determining a characteristic by performing the textual analysis, wherein the determining of the characteristic includes identifying a topic of a message sent by the customer to the one or more users of the social media company;
responsive to determining that the content is indicative of a gift-giving event, retrieving, by the financial institution computing system, financial reward offer content stored in a reward offer database to be delivered to the customer, the financial reward offer content related to the gift-giving event; and
transmitting, by the financial institution computing system over a network, the financial reward offer content to a computing device associated with the customer;
wherein the determining of the characteristic includes determining that the received social media information is indicative of a customer preference to receive a gift, and the transmitted reward offer content includes a first graphical interface that gives the customer the ability to indicate a preference to invite social media connections associated with the customer and with the financial institution to pool financial rewards points of the social media connections toward the financial reward offer to provide a gift to the customer.

14. The method of claim 13, further comprising:
creating a topic-based subdivision within the reward offer database based on the determined characteristic; and
storing the reward offer content related to the determined characteristic in the topic-based subdivision.

15. (canceled)

16. The method of claim 14, further comprising:
receiving, by the financial institution computing system, an indication of a customer preference to invite the social media connections to pool financial rewards points;
retrieving, by the financial institution computing system, information identifying social media connections of the customer from a customer database;
determining, by the financial institution computing system, a financial reward points balance for each of the identified social media connections;
retrieving, by the financial institution computing system, reward offer content from the reward offer database to be delivered to the identified social media connections based on the customer preference to receive a gift; and
transmitting, by the financial institution computing system, the financial reward offer content to a plurality of computing devices associated with the social media connections, the transmitted reward offer content including a second graphical interface that gives the social media connections the ability to indicate a preference to pool financial rewards points to benefit the customer.

17. The method of claim 16, further comprising:
receiving, by the financial institution computing system, a preference to pool financial rewards points towards the customer from a computing device associated with at least one social media connection, the pooling reward points preference indicating a pooling amount; and
delivering, by the financial institution computing system, a financial reward to the customer, the amount of the delivered financial reward being based on the pooling amount.

18. A mobile device, comprising:
a network interface configured to communicate data over a network;
an input/output device structured to exchange data with a customer;
a processor; and
a memory, the memory having executable instructions stored thereon that are structured such that, when executed by the processor, the processor is configured to:
receive a first input from the customer via the input/output device, the first input indicating a customer preference to communicate information on a social media platform related to a gift-giving event;
transmit, over the network by the network interface, the information contained in the first input to a computing system associated with the financial institution;
receive, over the network by the network interface, a financial reward offer from the computing system associated with the financial institution, the financial reward offer being related to the gift-giving event, the financial reward being determined based on textual analysis of customer communications on the social media platform, the customer communications directed to one or more social media connections associated with the customer and with the financial institution; and
present the received financial reward offer to the customer via the input/output device and provide the customer the ability to indicate a preference to invite the social media connections to pool financial rewards points of the social media connections toward the financial reward offer to provide a gift to the customer.

19. The mobile device of claim 18, wherein the event relates to a customer financial goal.

20. The mobile device of claim 18, wherein the received financial reward offer identifies a financial reward transaction and is presented to the customer as a graphical interface, the graphical interface providing the customer with the ability to indicate a preference to accept the received financial reward offer by engaging in the financial reward transaction, and wherein the processor is further configured to:
receive a second input from the customer via the input/output device, the second input indicating a customer preference to accept the financial reward offer;
transmit, responsive to the second input, a reward offer acceptance notification to the computing system associated with the financial institution over the network via the network circuit;
receive, over the network via the network interface, updated customer account information from the financial institution computing system, the updated customer account information reflecting the financial reward transaction; and
present a financial account interface to the customer via the input/output device, the financial account interface including the updated customer account information.
